(19) United States
(12) Patent Application Publication
(10) Pub. No.: US 2008/0307406 A1
(43) Pub. Date: Dec. 11, 2008

(54) DEVICE AND METHOD FOR CHECKING THE CURRENT SOFTWARE INSTALLATION IN FIELD DEVICES IN A DISTRIBUTED SYSTEM, IN PARTICULAR AN AUTOMATION SYSTEM

(75) Inventors: Dirk JOHN, Karlsruhe (DE); Dominik Eifel, Schwetzingen (DE); Frank Fengler, Minden (DE); Georg Hilsch, Minden (DE); Stefan Bollmeyer, Minden (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/134,332

(22) Filed: Jun. 6, 2008

(30) Foreign Application Priority Data
Jun. 8, 2007 (DE) 10 2007 026 602.4

(51) Int. Cl. G06F 9/44

(52) U.S. Cl. 717/171

(57) ABSTRACT

A device and a method for checking the current software installation in field devices in a distributed system, e.g., an automation system, which field devices communicate via a fieldbus with at least one control unit for system management, wherein the appliance library assistant means are implemented in the control unit and compare the current installation of a selectable field device with the latest available update versions, in order to initiate an update if a more recent update version is available.

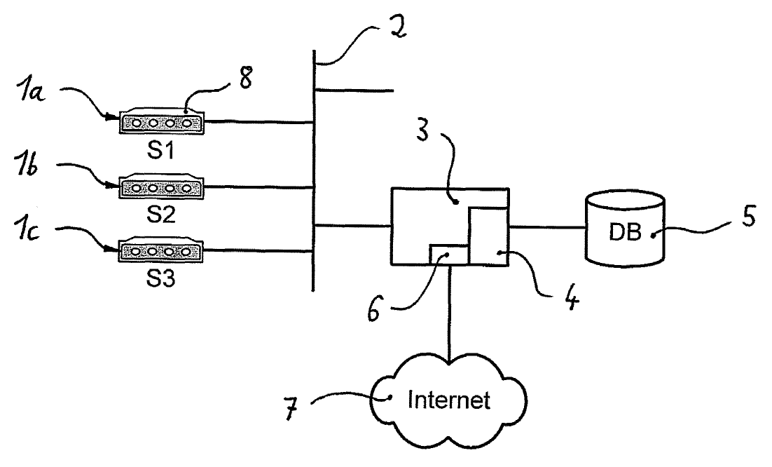

### RELATED APPLICATION

This application claims priority under 35 U.S.C. §119 to German Patent Application No. 10 2007 026 602.4 filed in Germany on Jun. 8, 2007, the entire content of which is hereby incorporated by reference in its entirety.

### TECHNICAL FIELD

The present disclosure relates to a device and a method for checking the current software installation in field devices in a distributed system, e.g., an automation system, which field devices communicate via a fieldbus with at least one control unit for system management.

### BACKGROUND INFORMATION

The field of application of the present disclosure predominantly covers automation systems in which system-internal communication is carried out using fieldbus protocols, such as FOUNDATION Fieldbus, PROFIBUS and/or HART. Suitable field devices for the purposes of the automation systems of interest here are preferably actuators, analysis appliances, drives, motor protection units, switchgear assemblies, sensors (e.g., sensors for pressure, temperature and flow measurements) and the like. A wide range of functions can be implemented in an automation system by the use of intelligent field devices and use of modern fieldbus protocols, such as control functions, setting-up functions, diagnosis functions, maintenance functions, optimization functions, alarm processing functions and life functions.

The technological trend is to integrate ever higher levels of field device information in the system in order to modernize working processes, to improve process and product quality, and to maximize availability. Configuration and diagnosis functions for system control in consequence likewise relate to the field devices.

Modern field devices are therefore becoming ever more complex and intelligent in their design and function. This is evident by the increasing number of parameters and functions of the field devices. A wide range of these parameters occur in appliance descriptions, such as appliance core data. This appliance description is a database file for the field device, also referred to as an appliance database, for specific Profibus appliances. The appliance core data file which is supplied by the appliance manufacturer contains a description of the appliance. Appliance core data files offer the capability for an open configuration tool in which they read very widely different appliance information items and identify the related quite complex appliance characteristics. All those involved in the development of digital fieldbus solutions are familiar with the difficulty of reliably maintaining the physical appliance and all of its characteristics throughout its entire life, to be precise starting from the choice of a suitable appliance type in the planning phase to its replacement in the event of the repair several years later. Inconsistencies in this respect cause additional planning effort and can lead to increased failures of an entire automation system.

The availability of the functional scope carried out by a field device over the entire life cycle of the automation system therefore forms a core aspect for the user. The provision of all functions which can be carried out by a field device in the various phases of the life of an automation system involves quite a large amount of effort. With regard to the life cycle of the automation system, this is not necessarily the same as the life cycle of a field device integrated in it, its description and its firmware. The software installed in a field device should always be at the current standard, for all of these reasons.

As is known, a user will generally check whether the firmware, the appliance drivers and other installed components are up to date at periodic time intervals, in order to update them if more recent versions are available, which have to comply with the requirement for backward compatibility. Software assistant means for this purpose are, for example, useful for telecommunications systems which are not of this generic type, such as domestic telephone systems. These assistant means are a component of a domestic appliance installation and can check, either continuously or on request by the user, for required updates for the installation, locally or via an Internet link to a central database. However, this has the disadvantage that appropriate updates are dependent on local installation of the appropriate assistant means and, when a dialling option is provided for the user for updating, it cannot be assumed that the entire mutual network system will have available the respectively latest update versions.

### SUMMARY

Exemplary embodiments disclosed herein can provide an update functionality for an automation system with field devices which communicate via a fieldbus, which functionality ensures the availability of the respectively latest update versions for the field devices in the system.

A device for checking the current software installation in field devices in a distributed system is disclosed, e.g., an automation system, which field devices communicate via a fieldbus with at least one control unit for system management, wherein appliance library assistant means are implemented in the control unit and compare the current installation of a selectable field device with the latest available update versions, in order to initiate an update if a more recent update version is available.

A method for checking the current software installation of field devices in a distributed system is disclosed, e.g., an automation system, which field devices communicate via a fieldbus with at least one control unit for system management, wherein appliance library assistant means which are implemented in the control unit compare the current installation of a selectable field device with the latest available update versions, with an update being carried out on this basis if a more recent update version is available.

In another aspect, a distributed system is disclosed, employing a method for checking the current software installation of field devices. An exemplary distributed system comprises field devices; a fieldbus with which the field devices communicate; and at least one control unit for system management of the field devices via the fieldbus, wherein the control unit compares the current installation of a selectable field device with the latest available update versions to carry out an update on this basis if a more recent update version is available.

### BRIEF DESCRIPTION OF THE DRAWING

Further measures to improve the disclosure will be described in more detail in the following text together with the description of one exemplary embodiment of the disclosure, and with reference to the single FIGURE. The FIGURE shows a schematic block diagram of an exemplary device for checking the current software installation of field devices in an automation system.

### DETAILED DESCRIPTION

The disclosure includes the technical teaching that appliance library assistant means are specifically implemented in a control unit for system management, which compare the current installation of a field device which can be selected with the latest available update versions, in order to initiate an appropriate update if a more recent update version is available.

According to the disclosure, e.g., updating can be carried out outside the installed operating software of a field device, specifically from a central system point. The current installation throughout the automation system can be kept up to date, in a standard form, from this central point. This relates both to firmware which in each case resides in the field devices and to the respective appliance descriptions and the like.

Updating to a new update version can be carried out in accordance with the following two exemplary alternatives. On the one hand, it is proposed that the control unit is associated with a database with an appliance library which can be updated, via which the appliance library assistant means obtain information about the latest available update versions of field devices. This is dependent on the database being updated to the latest standard at equidistant time intervals, that is to say on the new versions issued by the manufacturers being read into it.

According to the second alternative, which makes this unnecessary, it is proposed that the control unit is equipped only with a connection interface, via which the implemented appliance library assistant means obtain information about the latest available update versions of field devices. This can be done via the Internet. The connection interface via the Internet therefore to this extent sets up a connection between the appliance library assistant means for the automation system and an update database of the manufacturer of a field device installed in the automation system.

In order to achieve planned updating of the installation for every field device which is available in an automation system, a further measure as an improvement to the disclosure proposes that the appliance library assistant means check each field device in the system successively, in a sequence which can be defined. The sequence may be based on the sequence of the various appliance types, such as actuators, sensors and the like, or may be carried out on an appliance-type neutral basis for the various functional areas of an automation system, such as field devices for workpiece transport, field devices for workpiece machining, and the like. This allows the entire automation system to be completely and systematically matched, preventing the risk of a field device being forgotten when checking the current software installation.

According to another measure as an improvement to the disclosure, it is proposed that, if a more recent update version is available, the appliance library assistant means make an update proposal to the operator. The update is not carried out until the operator has acknowledged this proposal. This procedure ensures that any field devices which may need to be deliberately excluded from an update in an automatic system are not supplied with undesired update versions in an uncontrolled manner. This may on occasion be necessary when the backward compatibility of more recent update versions does not operate, and would cause a system malfunction.

However, as an alternative to acknowledgement by the operator, a maintenance management unit can also be integrated in the control unit for system management, to carry out the operator task as described above. This is dependent on the maintenance management unit having previously been fed with any exceptions to automatic updating of field devices, for example in the form of an exception list.

Yet, another further exemplary measure to improve the disclosure is that, if a more recent update version is available with an upgraded functional scope, the appliance library assistant means makes a proposal to the operator to upgrade the functions. This functional upgrade is integrated in the associated field device only once the operator has acknowledged a proposal such as this. For example, a new update version may contain an additional function relating to a self-test to be carried out at time intervals which can be defined and which was not included in the previous software installation. The prior check with the operator ensures that a functional upgrade such as this is implemented only if the operator wishes to do so. If the operator does not consider that a function upgrade such as this is worthwhile, then he has the capability to prevent it.

As shown in the FIGURE, an automation system comprises a plurality of field devices 1a-1c which communicate via a fieldbus 2 with a control unit 3, which is likewise integrated in the automation system. In this case, the control unit 3 is used for system management and, for example, monitors the number, type, maintenance status, availability of the field devices 1a-1c, which are each equipped with a local control unit 8.

In this exemplary embodiment, the fieldbus 2 is in the form of a FOUNDATION fieldbus. The field devices 1a-1c are associated with the sensor type, specifically a pressure sensor.

Appliance library assistant means 4 are implemented as software in the control unit 3, and are a component of it. The appliance library assistant means 4 embody a checking algorithm, which interacts with the individual field devices 1a-1c, in order to determine the current installation of the field devices 1a-1c in the automation system, in order to compare this with the latest available update versions at a central point in the control unit 3. If this comparison indicates the existence of a more recent update version for one of the field devices 1a-1c, the appliance library assistant means 4 initiate the update, with the more recent update version being installed in the relevant field device 1a, 1b or 1c.

For this purpose, the control unit 3 is connected to a database 5 in which the more recent update versions are kept. The database 5 therefore has an appliance library, which can be updated, for the control unit 3.

The control unit 3 is also equipped with a connection interface 6 via which a link can be set up to the Internet 7. This means that the appliance library assistant means 4 are able to search for the latest available update versions via the Internet in databases, which are not illustrated in any more detail, of manufacturers of the field devices 1a-1c in the automation system, and either to use these directly for updating the automation system or to store them for the time being in the database 5 until the next planned time occurs for an update run for the software installation in the field devices 1a-1c.

The appliance library assistant means 4 check each field device 1a-1c successively in a sequence defined by the operator of the automation system, to ensure that the software installation is up to date. In this process, the appliance library assistant means 4 take account at least of the software types of firmware and appliance driver and, possibly, also of other functional upgrades. If a more recent update version is available, the appliance library assistant means 4 do not implement an update in the relevant field device 1a-1c until the operator has previously acknowledged an update proposal, which is acknowledged via an operator interface. The operator interface may in this case be in the form of a screen with an appropriate control interface in conjunction with input means that have been known for a long time, such as a mouse, keyboard and the like.

The disclosure is not restricted to the exemplary embodiment described above. In fact, modifications of it are also feasible and are also covered by the scope of protection of the following claims. For example, it is also possible to use other types of field devices as sensors, in conjunction with the solution according to the disclosure. Furthermore, other normal fieldbus protocols are also suitable for system-internal communication. Furthermore, a link to the manufacturer databases via the Internet in order to update available update functions is not essential, and, instead, these may also, for example be actively fed into the database in accordance with appropriate contractual obligations from the manufacturer, or may be made available in some other way to the appliance library assistant means according to the disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

1 Field device
2 Fieldbus
3 Control unit
4 Appliance library assistant means
5 Database
6 Connection interface
7 Internet
8 Control unit (local)

What is claimed is:

1. A device for checking the current software installation in field devices in a distributed system, which field devices communicate via a fieldbus with at least one control unit for system management, wherein
appliance library assistant means are implemented in the control unit and compare the current installation of a selectable field device with the latest available update versions, in order to initiate an update if a more recent update version is available.

2. The device as claimed in claim 1, wherein
the control unit is associated with a database with an appliance library which can be updated, via which the appliance library assistant means obtain information about the latest available update versions of field devices.

3. The device as claimed in claim 1, wherein
the control unit is equipped with a connection interface via which the implemented appliance library assistant means obtain information about the latest available update versions of field devices.

4. The device as claimed in claim 1, wherein
the fieldbus is configured on the basis of standardized bus protocols, comprising PROFIBUS, FOUNDATION Fieldbus, HART.

5. The device as claimed in claim 1, wherein
each field device comprises a local electronic control unit and an appliance which can be driven electrically via it, comprising an actuator, sensor, drive and analysis appliance.

6. The device as claimed in claim 1, wherein
the appliance library assistant means compare the actual installation of at least two different software types, comprising firmware and appliance driver.

7. A method for checking the current software installation of field devices in a distributed system, which field devices communicate via a fieldbus with at least one control unit for system management, wherein
appliance library assistant means which are implemented in the control unit compare the current installation of a selectable field device with the latest available update versions, with an update being carried out on this basis if a more recent update version is available.

8. The method as claimed in claim 7, wherein
the appliance library assistant means check each field device in the system successively, in a sequence which can be defined.

9. The method as claimed in claim 7, wherein
if a more recent update version is available, the appliance library assistant means make an update proposal to the operator or to a maintenance management unit, which update is carried out only when this proposal has been acknowledged by the operator or the maintenance management unit.

10. The method as claimed in claim 7, wherein,
if a more recent update version is available with an upgraded functional scope, the appliance library assistant means make a proposal to the operator to upgrade the functions, and this is carried out only when the operator has acknowledged this proposal.

11. A device as claimed in claim 1, wherein
the appliance library assistant means search for the latest available update versions outside the system, and these versions are stored jointly in a database which contains an appliance library.

12. The device as claimed in claim 11, wherein
the appliance library assistant means search for the latest available update versions on the Internet.

13. The device as claimed in claim 1, wherein the distributed system is an automation system.

14. The method as claimed in claim 7, wherein the distributed system is an automation system.

15. A distributed system employing a method for checking the current software installation of field devices, comprising:
field devices;
a fieldbus with which the field devices communicate; and
at least one control unit for system management of the field devices via the fieldbus, wherein the control unit compares the current installation of a selectable field device with the latest available update versions to carry out an update on this basis if a more recent update version is available.
